(19) United States
(12) Patent Application Publication
(10) Pub. No.: US 2006/0225266 A1
(43) Pub. Date: Oct. 12, 2006

(54) Sleeving apparatus and method

(75) Inventor: Terrence C. Fredrickson, Belleville (CA)

Correspondence Address: DORSEY & WHITNEY LLP;INTELLECTUAL PROPERTY DEPARTMENT, 250 PARK AVENUE, NEW YORK, NY, 10177, US

(73) Assignee: Halla Climate Control Canada Inc.

(21) Appl. No.: 11/103,016

(22) Filed: Apr. 11, 2005

(51) Int. Cl. B21D 39/00; B23P 19/02

(52) U.S. Cl. 29/452; 29/235

(57) ABSTRACT

An open end of sleeving is placed onto a first end of a piece of tubing. A suction clamp, mounted on a movable carriage, is placed over the sleeving, at or near the open end. Compressed air is applied within a second end of the tubing. A cinch is applied to the sleeving at a distance from the tubing. The cinch allows the sleeving to be pulled through the cinch, but also creates a hermetic seal within the sleeving. The compressed air flows through the tubing and is blocked by the hermetic seal, thereby forcing the air out between an outer surface of the tubing and an inner surface of the sleeving. The carriage then moves towards the second end of the tubing, pulling the sleeving along the tubing.

### FIELD OF THE INVENTION

The invention relates to an apparatus and a method for installing flexible sleeving onto piping and/or tubing.

### BACKGROUND OF THE INVENTION

In the automotive industry, for example, foam sleeving (or other types of sleeving material) is used to insulate air conditioning and heater lines, which pass under a vehicle body (under-body lines) and are also present in the engine compartment (under-hood lines).

In vehicles having either a rear heating or a rear air conditioning system, hot and cold fluids must be transported from the engine compartment to the evaporator and/or heater cores located at the rear of the vehicle. To optimize or improve performance, heat loss should be minimized through these lines. To insulate against the environment, flexible foam sleeving is typically installed over top of the under-body lines. The flexible foam sleeving helps to keep the cold lines cold and the hot lines hot.

There are many other applications and industries where it is necessary or desirable to install flexible sleeving over piping or tubing.

Such sleeving is typically installed over the tubing by hand. However, installing sleeving by hand is slow, labour intensive and puts workers at risk of repetitive strain injuries. It would be desirable to improve productivity and efficiency and reduce the risk of worker injury.

### SUMMARY OF THE INVENTION

An embodiment of the present invention provides for an apparatus for installing flexible sleeving (“sleeving”) onto rigid or semi-rigid piping and/or tubing. The apparatus or machine is automated, limiting the amount of human interaction. In one embodiment, the only human interaction is to place the sleeving onto one end of the tubing.

The sleeving material is fed through a cinching mechanism which allows the sleeving material to be pulled through the cinching mechanism but also creates and maintains a substantially hermetic seal within the sleeving material adjacent the cinching mechanism. The sleeving is placed over a first end of the tubing. Compressed air is blown into the other end of the tubing. When the compressed air reaches the seal, the air changes direction and is forced between an outside surface of the tubing and an inside surface of the sleeving, causing the sleeving to expand around the tubing. Once expanded, the sleeving can then be pulled over the remainder of the tubing with minimal resistance. Thermal knives are then used to cut the sleeving, at which point, the combination of the tubing with the surrounding sleeving is unloaded to a storage bin.

Embodiments of the apparatus and method described herein could be used to insulate under-body air conditioning and heater lines for vehicles. Other embodiments could be used to apply sleeving to piping on chemical reactor tanks that need to be insulated against heat loss or gain or, for example, to refrigeration tubing in commercial heating, ventilation, and air conditioning (HVAC) units. Other embodiments of the present invention could be used to apply sleeving to rigid (or semi-rigid) piping and/or tubing for other purposes.

According to a further aspect of the present invention, the invention provides a method for applying flexible sleeving over tubing, the method comprising—placing an open end of the sleeving over a first end of the tubing;—applying a cinch to the sleeving wherein the cinch creates a seal within the sleeving at a distance from the tubing and the cinch allows the sleeving to be moved through the cinch towards a second end of the tubing while maintaining a seal within the sleeving, at a distance from the tubing;—applying gas into the second end of the tubing;—moving the open end of the sleeving towards the second end of the tubing; thereby covering the tubing with the sleeving.

According to another aspect of the present invention, the invention provides an apparatus for applying flexible sleeving over tubing, the apparatus comprising—a cinch adapted to create a seal within the sleeving at a distance from the tubing and the cinch also being adapted to allow the sleeving to be moved through the cinch towards a far end of the tubing while maintaining a seal within the sleeving at a distance from the tubing;—a conduit for applying gas into the far end of the tubing;—a sleeving mover adapted to move the sleeving along the tubing.

According to another aspect of the present invention, the invention provides an apparatus for applying flexible sleeving over tubing, the apparatus comprising—a cinching means adapted to create a seal within the sleeving at a distance from the tubing, and the cinching means also being adapted to allow the sleeving to be pulled through the cinching means towards a far end of the tubing while maintaining a seal within the sleeving, at a distance from the tubing;—a means for applying compressed air into the far end of the tubing; and—a moving means for moving the sleeving over the tubing.

Different embodiments of the present invention may provide some of the following features and advantages: an automated or semi-automated apparatus for installing flexible sleeving material onto rigid piping or tubing provides a relatively simple, cost effective and repeatable process which improves efficiency and reduces the risk of worker injury; the automated or semi-automated apparatus or method reduces cycle time required for installing insulated material onto piping or tubing; embodiments of the present invention provide an apparatus and method for installing insulating material over tubing or piping that produces less waste than previous methods and apparatus; embodiments of the present invention, by providing an automated or semi-automated process reduce the cost of producing insulated lines in view of reduced operator involvement; embodiments of the present invention provide a customizable apparatus and method for applying flexible sleeving to piping or tubing where the piping or tubing can have different lengths or diameters.

### BRIEF DESCRIPTION OF THE DRAWINGS

Preferred embodiments of the invention will now be described with reference to the attached drawings in which:

FIG. 1 is a perspective view of a sleeving apparatus according to one embodiment of the present invention;

FIG. 2 is a perspective view of the moveable carriage of FIG. 1;

FIG. 3 is a side, sectional view of the portion of tubing secured by an end support/clamp in accordance with an embodiment of the present invention;

FIG. 4 is a perspective view of a portion of the apparatus of FIG. 1 showing, among other things, the moveable carriage and the cinching mechanism;

FIG. 5 is a perspective view of a portion of the apparatus of FIG. 1 showing, among other things, the center support and arms for displacing tubing;

FIG. 6 is a perspective view of a portion of the apparatus of FIG. 1 showing, among other things, the end support and a nozzle for delivering compressed air;

FIGS. 7a-d are perspective views of the arms of FIG. 5 for displacing tubes in different orientations, namely:

FIG. 7a is a perspective view of the arms in a lowered and retracted position;

FIG. 7b is a perspective view of the arms in a lowered and extended position;

FIG. 7c is a perspective view of the arms in a partially raised position;

FIG. 7d is a perspective view of the arms in a raised position;

FIGS. 8a and 8b are side views of a cinching mechanism, in a closed and open position, respectively, in accordance with an embodiment of the present invention; and

FIG. 8c is a side view of sleeving applied over direction changers, in accordance with another embodiment of the present invention.

### DETAILED DESCRIPTION

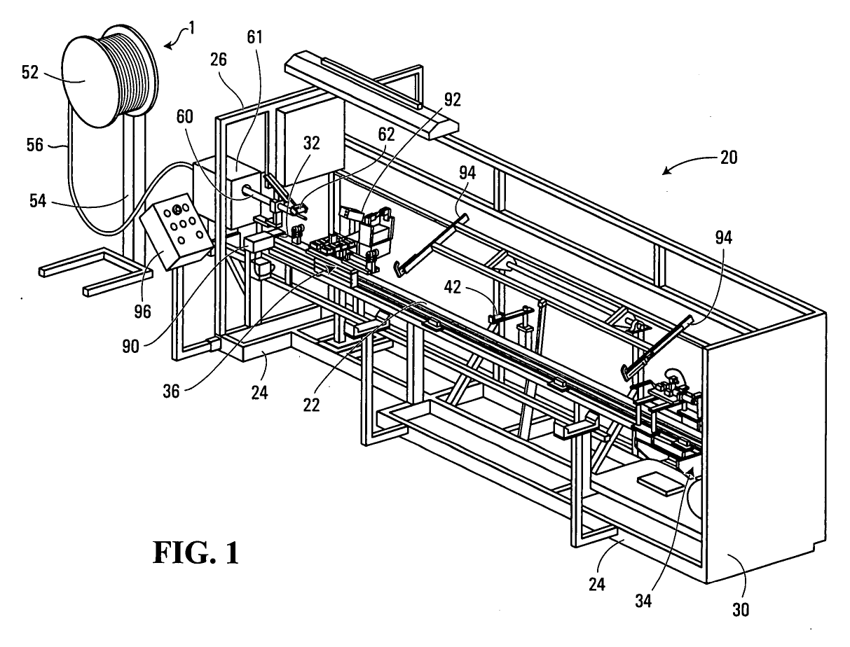

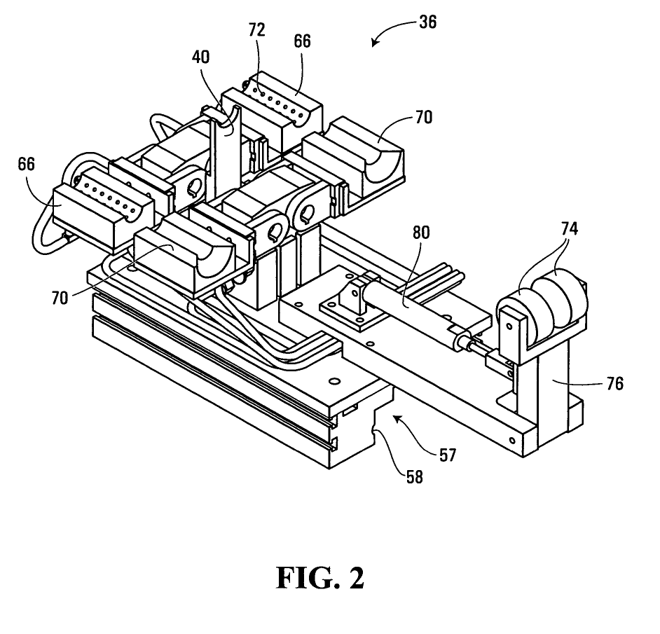

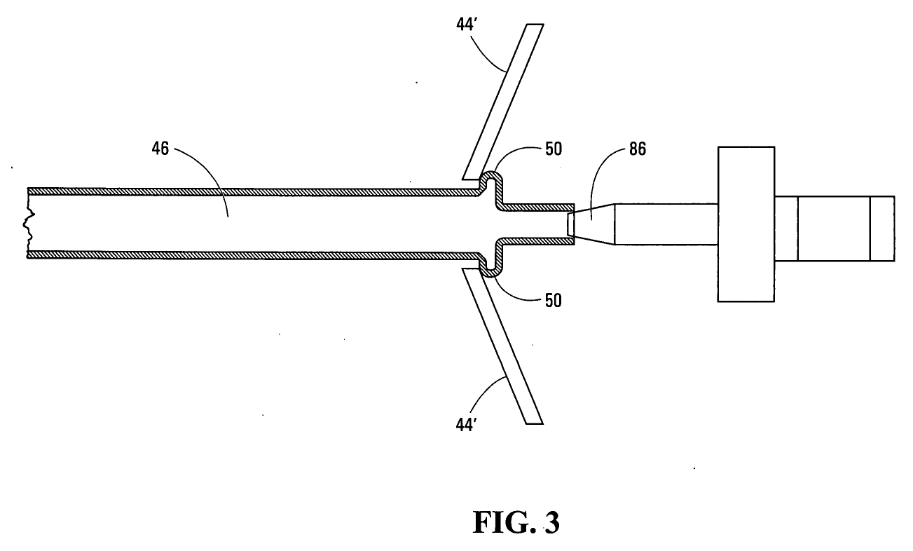

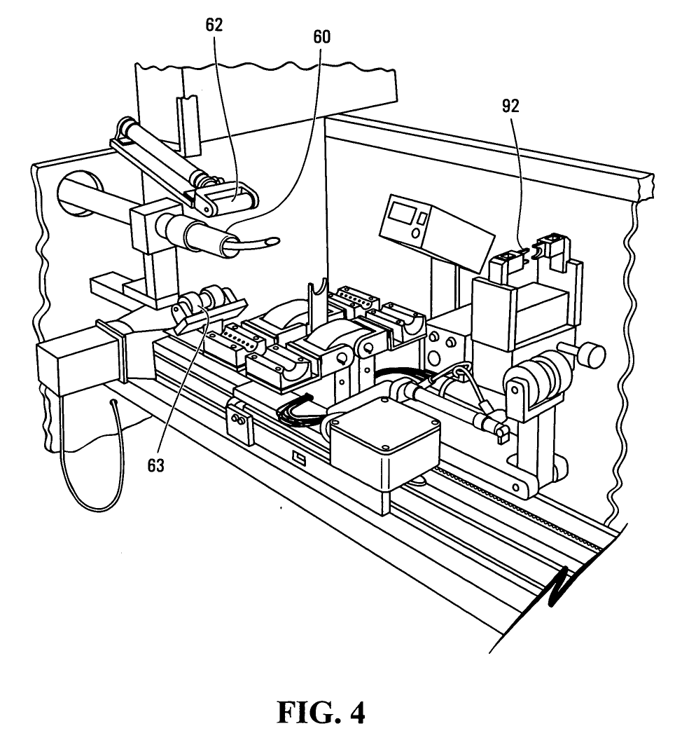

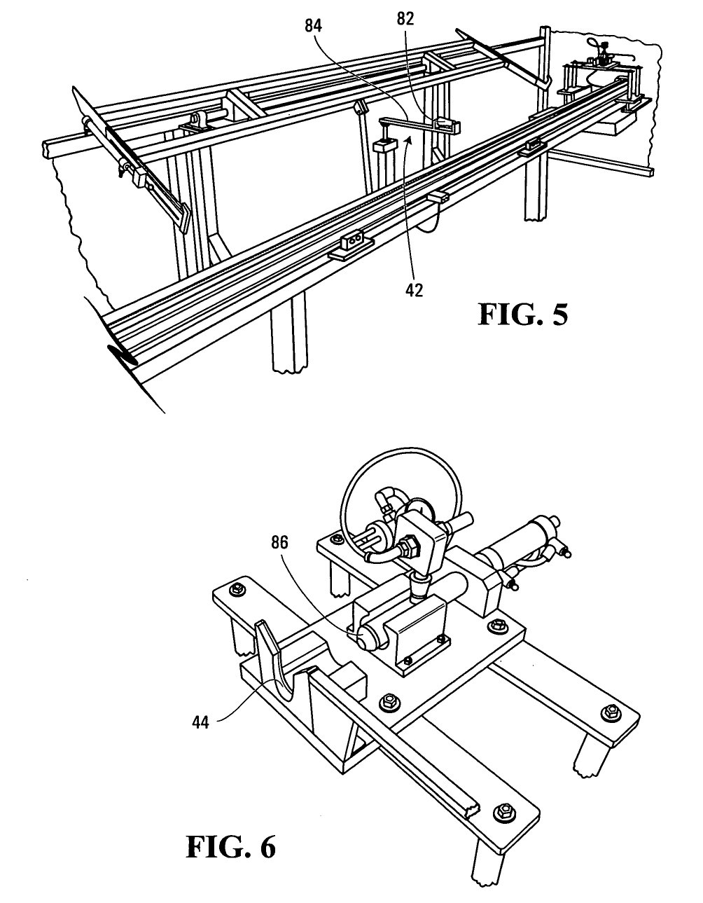

A perspective view of a sleeving apparatus 20 in accordance with an aspect of the present invention is shown in FIG. 1. A track 22 is supported by a stationary base frame 24. The frame 24 has a first end 26 and a second end 30. The track 22 extends from a first end 32 to a second end 34. A movable carriage assembly 36 (or “carriage”) as perhaps best seen in FIG. 2, is mounted on the track 22, to allow movement of the carriage 36 along the track 22. A number of supports and/or clamps are distributed above the track 22. An initial support 40 (see FIG. 2) extends upward from the movable carriage 36, in this embodiment. A centre support 42 is positioned above the track 22, approximately halfway along the length of the track 22. An end support 44 (see FIG. 6) is positioned above the track 22, near the second end 34 of the track. In one embodiment, an end support could also be a clamp, to help hold tubing 46 in position. (Hereinafter, “tubing” may refer to tubing or piping.) In another embodiment, an end clamp could be separate from the end support 44. One alternate embodiment is shown in FIG. 3 where the tubing 46 has a portion 50 of increased diameter. An end support/clamp 44′ supports the tubing 46 and prevents the tubing 46 from moving toward the left in this Figure.

In the embodiment of FIG. 1, a rotatable dispensing spool 52 is mounted on a supporting frame 54. Insulating or sleeving material 56 (sometimes referred to as “sleeving”) is wound around the spool 52, with a loose end fed through one or more support tubes 60 in a direction towards the second end 34 of the track. In this embodiment, the sleeving material 56 and a part of the support tube 60 extend through a cinch mechanism cover 61. The sleeving material 56 exits the support tube 60 near an upper guide roller 62.

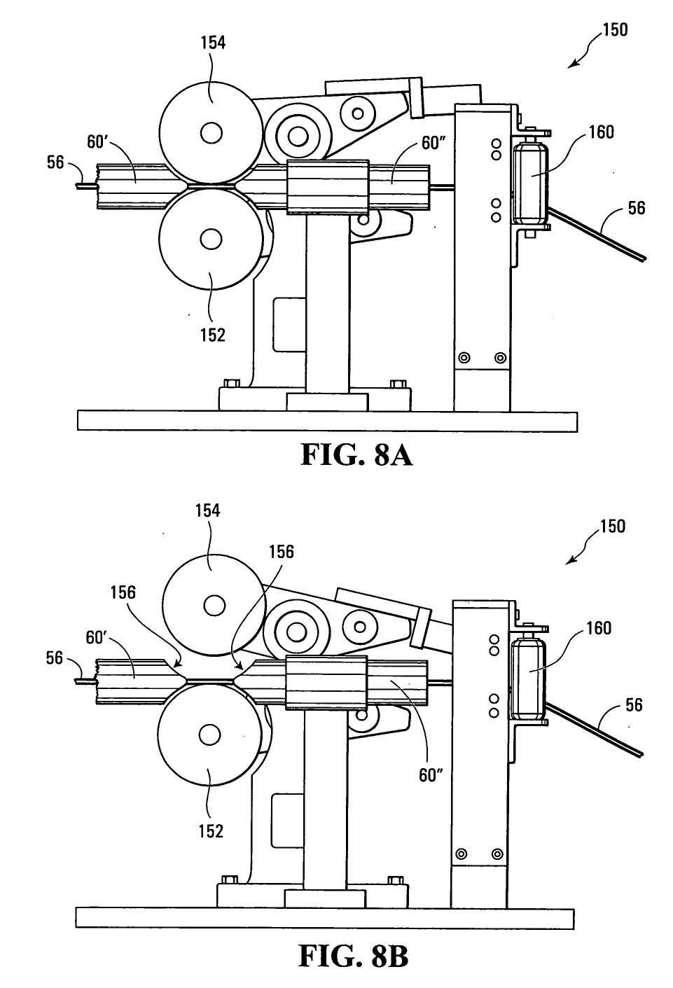

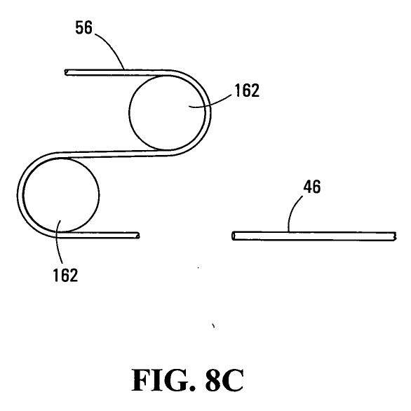

Within the cinch mechanism cover 61 is a cinch mechanism (which may also be referred to as a cinching means or a cinch). One embodiment of a cinch or cinching mechanism 150 is shown in FIGS. 8a and 8b.

The cinch mechanism 150 has two pneumatically displaceable cinch rollers 152, 154. In this embodiment, the cinch rollers 152, 154 are positioned between two support tubes 60′, 60″. The sleeving material 56 is exposed in a gap between the two support tubes 60′, 60″. Ends 156 of the support tubes 60′, 60″ are shaped to match the contour of the adjacent cinch rollers 152, 154.

(It should be noted that FIGS. 8a and 8b depict an embodiment slightly different from the embodiment of FIG. 1. In FIGS. 8a and 8b, the sleeving material 56 is fed through vertical guide rollers 160, which are absent from the embodiment of FIG. 1.)

A close-up, perspective view of the carriage 36 mounted on the track 22 is shown in FIG. 2. The carriage 36 is mounted on the track 22 by guides 57 in nearly frictionless contact through use of linear bearings, which, in this embodiment, would ride in the half slot 58 of the guide 57. The initial support 40 has a semi-circular top portion and is mounted on the carriage assembly 36. In this embodiment, one clamp, a vacuum clamp 66 (or a suction clamp), is positioned between the initial support 40 and the first end 32 of the track 22. Another clamp, a support or guide clamp 70, is positioned on the other side of the initial support 40. Each clamp 66, 70 has two halves, namely a first half and a second half. In this embodiment, each half is adapted to pivot upward 90° to provide clamping around a piece of rigid piping or tubing. Each half of each of the clamps 66, 70 has a semi-circular section of appropriate diameter. The diameter of the guide clamp 70 is slightly greater than the diameter of the tubing 46. The diameter of the vacuum clamp 66, when the halves of the clamp 66 are closed, is slightly greater than the diameter of the sleeving material 56 when the sleeving material 56 is applied over the tubing 46.

Holes 72 are formed within the semi-circular portion of the vacuum clamp 66. The holes 72 extend to a vacuum mechanism (not shown) to suck air towards the vacuum mechanism.

The carriage 36 incorporates rollers 74 to help support the tubing and permit the carriage 36 to advance smoothly under the tubing 46. In this embodiment, the rollers 74 are supported by a roller support arm 76, which is pivotally mounted to the carriage 36. A pneumatic cylinder 80 is mounted to the roller support arm 76. The pneumatic cylinder 80 allows the roller support arm 76 to pivot 90 degrees, from the vertical position shown in FIG. 2 to a horizontal position (not shown).

As noted above, the centre support 42 is positioned above the track 22, approximately halfway along the length of the track 22. The centre support 42 incorporates a roller wheel 82 made of plastic or other non-abrasive material. The roller wheel 82 is mounted on a pivoting arm 84, which arm 84, in this embodiment, rotates 90° to either side to avoid being contacted by the passing carriage 36.

A nozzle 86 is positioned between the second end 30 of the frame 24 and the end support 44. The nozzle 86 is connected (through a conduit (not shown)) to a compressor for producing compressed air (not shown).

In this embodiment, a servo motor 90 is mounted near the first end 26 of the apparatus 20. The servo motor 90 is connected to the carriage 36 by a belt (not shown). The servo motor 90 controls the speed of advancement of the carriage 36 along the track 22. The servo motor 90 is capable of moving the carriage 36 both forwards and backwards.

The cinching mechanism 150, in this embodiment, may be mounted to the base frame 24 between the spool 52 and the carriage 36. The cinching mechanism 150 is, in this embodiment, pneumatically extended. FIG. 8b shows the cinching mechanism 150 with the upper cinch roller 154 in the raised position. FIG. 8a shows the cinch rollers 152, 154 in the closed position, where they compress opposite sides of the sleeving material 56 to provide a temporary hermetic seal with the sleeving material 56. However, it is not necessary for the seal to be hermetic. As well, in one embodiment, the cinch rollers 152, 154 are independently driven (rotated) to help move the sleeving material 56 through the cinch mechanism 150. Advantageously, the cinch rollers 152, 154 are driven at a speed consistent with the rate at which the sleeving material 56 is being pulled towards the second end 30 of the base frame 24.

The upper guide roller 62 is, in this embodiment, pneumatically extended. The non-abrasive upper guide roller 62 is mounted on a pneumatic piston which extends downward and a non-abrasive lower guide roller 63, mounted on a pneumatic piston (not shown), extends upward. The upper guide roller 62 and the lower guide roller 63 extend towards each other to help guide the sleeving material 56 and to help support the tubing 46 as the carriage 36 moves toward the second end 30 of the base frame 24.

Heating blades 92 are mounted on pneumatic cylinders. The blades 92 are made of a durable conductive material, such as steel, that are heated to a temperature suitable to melt the sleeving material 56. Each of the blades 92, in this embodiment, is a half-circle, designed so that when they come together, they encircle the tubing 46, touching the sleeving material 56 at every point in its circumference, melting the sleeving material 56 at every point of contact, thus severing it. The blades 92 are calibrated specifically so that no abrasion or damage is left on the tubing 46 after the sleeving material 56 has been cut.

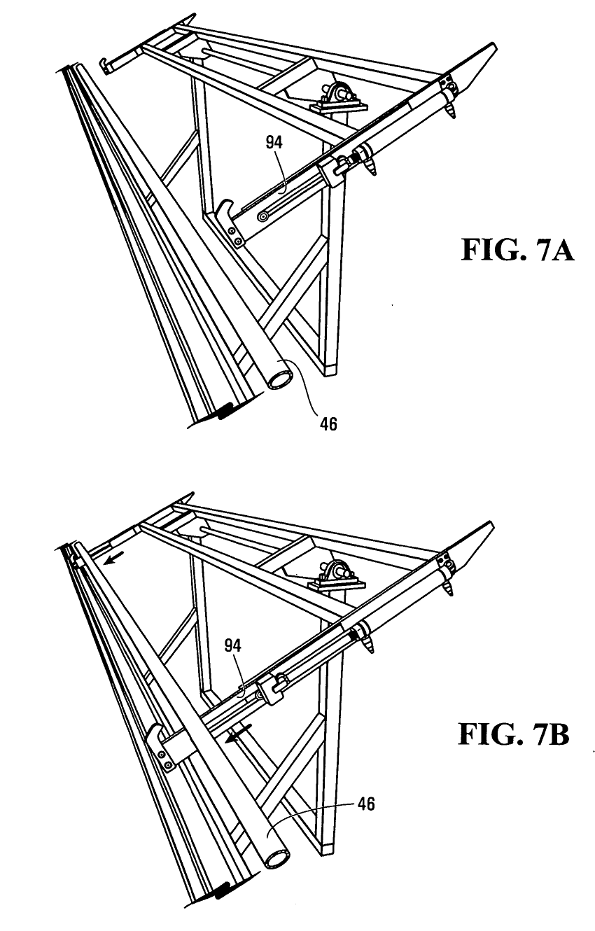

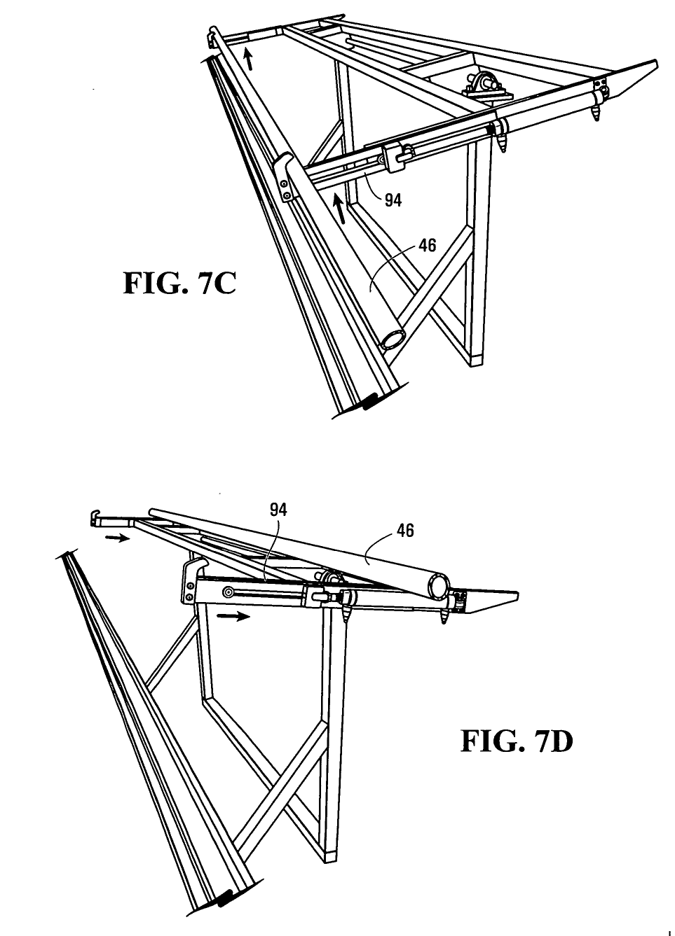

The sleeving apparatus 20 also incorporates pneumatically actuated arms 94 to displace the tubing 46 into a waiting hopper (not shown). The arms 94 can move up and down and can extend. FIG. 7a shows the arms 94 in a lowered and retracted position. FIG. 7b shows the arms 94 in the lowered and partially extended position. FIG. 7c shows the arms 94 in a partially raised position. FIG. 7d shows the arms in a raised position, to displace the tubing into a waiting hopper (not shown).

All of the interactions and movements described above are controlled by a logic control device housed in a cabinet 96. The “brain” of the logic control device may be a standard industrial “programmable logic controller” or “PLC”, which replaces relays, timers, and counters that may otherwise be needed to ensure that all the functions occur at the proper time and in the proper order. The PLC actuates electric valves that turn on air to appropriate pneumatic cylinders at proper times, causes the servo motor 90 to move the carriage 36, causes the blades 92 to heat, etc. The PLC also monitors limit switches (not shown) and safety interlocks (not shown) to ensure safe operation (although by law there is likely an independent circuit to ensure that the safety functions operate even if the PLC fails). The PLC is programmed by connecting it to a separate computer (not shown) and using special software (now shown).

In operation, an embodiment of the sleeving apparatus 20 functions as follows. First, tubing 46 is placed (manually or automatically) on the initial support 40, the centre support 42 and the end support 44. The tubing 46 has a first end towards the first end of the frame and a second or far end towards the second end of the frame.

In this embodiment, the two halves of the guide clamp 70 are pivoted around the tubing 46. An open end of the sleeving material 56 is then fed through the support tube 60′, and the support tube 60″, and is placed over the first end of the tubing 46 and the sleeving material 56 is slid up to the guide clamp 70 by the operator. (In another embodiment, this operation could be automated.) The two halves of the vacuum clamp 66 are then pivoted around the tubing 46.

The cinching mechanism 150 is pneumatically extended to compress the sleeving material 56 between the upper roller 154 and the lower roller 152 creating a temporary seal, which may be a hermetic seal. The cinching mechanism 150 is applied to a portion of the sleeving material 56 that has not been inserted over the tubing 46. The portion of the sleeving material 56 that has not been inserted over the tubing 46 may be referred to as a “remaining portion” of the sleeving material 56. Accordingly, the cinching mechanism 150 will create a seal within the sleeving at a distance from the tubing 46.

Suction is then introduced through the holes 72 of the vacuum clamp 66, effectively drawing the sleeving material 56 away from the tubing 46 and towards the semi-circular contours of the vacuum clamp 66. Maintaining suction or a vacuum during the installation of the sleeving material 56 helps to ensure that the sleeving material 56 does not slip or bind on the tubing 46.

Compressed air is then directed through the nozzle 86 into the second end of the tubing 46. The compressed air from the nozzle 86 travels through the tubing 46 along its length. The seal in the sleeving material 56 created by the cinching mechanism 150 acts as a barrier. When the compressed air reaches the barrier, the air changes direction and is forced between the outside of the tubing 46 and the inside of the sleeving material 56.

The servo motor 90 then steadily moves the carriage 36 towards the second end 30 of the apparatus 20. As noted above, the cinch rollers 152, 154, advantageously, are driven to rotate at a speed comparable to the rate of movement of the carriage 36, to assist movement of the sleeving through the cinch mechanism 150. As the carriage 36 moves, sleeving material 56 from the spool 52 is drawn through the cinching mechanism 150, but the cinching mechanism 150 continues to apply a seal within the sleeving material 56 at a distance from the first end of the tubing 46. The sleeving material 56 is drawn or moved along the length of the tubing 46 as the compressed air causes the diameter of the sleeving material 56 to expand. The vacuum clamp 66 secured to the carriage 36 may be referred to as a sleeving mover or a moving means.

As the carriage 36 reaches the centre support 42, the centre support 42 is pivoted so that it does not interfere with the movement of the carriage 36. (In one embodiment, the centre support 42 could be pivoted back to the original position after the carriage 36 has moved beyond the centre support 42.)

When the carriage 36 moves towards the second end of the tubing 46, the first end is supported, in the embodiment of FIG. 1, by the upper and lower guide rollers 62, 63.

When the sleeving material 56 has been installed over the length of the tubing 46, the vacuum is turned off or withdrawn and the compressed air is turned off or withdrawn, thereby allowing the sleeving material 56 to close around the tubing 46.

The carriage 36 is then retracted to its home or initial position.

The heating blades 92 are then heated and positioned to engage the sleeving material 56 to melt the sleeving material 56, separating or severing the sleeving material 56 inserted over the tubing 46 from the remaining portion of the sleeving material 56. Many other different techniques known to those skilled in the art could be used to separate the sleeving material 56.

The removal or dispensing arms 94 are then activated to lift the tubing 46 into a hopper (not shown). The arms 94 are lowered and then extended under the tubing 46. The arms 94 are then raised, to allow the tubing 46 to roll down the arms 94 into a hopper.

A further piece of tubing can now be placed on the apparatus 20 and the procedure can be repeated.

The apparatus and method described above may be modified in many different manners. For example, the end support 44 may be secured to a movable tabletop (not shown) so that it can be adjusted to accommodate varying lengths of tubing.

Moreover, the apparatus 20 may be modified to accept and assemble tubing of varying diameters and material. Changing the profile of the clamps and supports would accommodate tubing of different diameters.

The method and apparatus could also be used to apply sleeving over only a portion of the length of a piece of tubing rather than along the entire length.

The method and apparatus described above use a vacuum clamp to apply a force on the sleeving material 56 away from the circumference of the tubing 46. However, other techniques could be used to apply a similar force to the leading edge of the sleeving material 56. For example, a series of pinchers, pliers, or variations of pliers (not shown) could be used to apply a force to the leading edge of the sleeving material 56. As another alternative, if the sleeving material 56 is attracted to or repelled by a magnet, magnets could be used instead of the vacuum clamp. Similarly, substances that repel or attract the sleeving material 56 could also be used.

In another embodiment, the compressed air or other gas could, on its own, provide enough force or create a sufficient gap between the open end of the sleeving material 56 and the tubing 46 or reduce friction sufficiently to avoid the need to apply suction. In that case, it would be necessary to separately pull or push the leading edge of the sleeving material 56 towards the second end of the tubing 46 while the compressed air is being applied. Many different types of suitable sleeving movers or moving means could be used to pull or push the sleeving material 56.

As described above, pneumatics are used to close and lock, for example, the clamps 66, 70 and to operate the cinching mechanism 150 and removal arms 94 and other features of the sleeving apparatus 20. However, many different techniques are known for accomplishing these functions and could be used instead.

Similarly, many different techniques are available to load and unload the tubing 46. Only one such technique was described above.

In the embodiment described above, the carriage 36 is moved by a belt and servo motor 90. However, many other techniques could be employed for moving the carriage 36 such as, for example, a rack and pinion type system or a helical screw device.

The sleeving material 56 was described above as being dispensed off a spool 52. However, any technique capable of delivering sleeving material at a steady rate could be employed. For example, a coil of sleeving material placed strategically on the floor beside the apparatus would suffice, if it is positioned in such a manner that would not inhibit the smooth dispensing of the sleeving material.

The cinching mechanism 150 was described above as having two rollers 152, 154 coming together to compress opposite sides of the sleeving material 56. However, different types of cinching mechanisms could also be used. For example, the cinching mechanism 150 could incorporate one roller compressing against a non-roller surface (not shown). Alternatively, the cinching mechanism 150 could incorporate two non-roller surfaces compressing against each other (not shown). As another alternative, as suggested in FIG. 8c, the sleeving material 56 could be routed over one or more direction changers 162 (which could be pulleys, rollers or other surfaces) before the sleeving material 56 is inserted over the tubing 46. The direction changer(s) 162 would effectively create a seal within the sleeving material 56 and also allow the sleeving material 56 to be pulled onto the tubing 46 while maintaining the seal.

Numerous other modifications and variations of the present invention are possible in light of the above teachings. It is therefor to be understood that within the scope of the appended claims, the invention may be practiced otherwise then as specifically described herein.

What we describe as our invention is:

1. A method for applying flexible sleeving over tubing, the method comprising
placing an open end of the sleeving over a first end of the tubing;
applying a cinch to the sleeving wherein the cinch creates a seal within the sleeving at a distance from the tubing and the cinch allows the sleeving to be moved through the cinch towards a second end of the tubing while maintaining a seal within the sleeving, at a distance from the tubing;
applying gas into the second end of the tubing;
moving the open end of the sleeving towards the second end of the tubing;
thereby covering the tubing with the sleeving.

2. The method of claim 1 wherein the cinch creates a hermetic seal in the sleeving.

3. The method of claim 1 wherein applying gas comprises applying compressed air.

4. The method of claim 1 wherein moving the open end of the sleeving towards the second end of the tubing comprises applying suction around the sleeving, at or near the open end of the sleeving, the suction applying a force on the sleeving away from the tubing, and then moving the open end of the sleeving towards the second end of the tubing.

5. The method of claim 4 wherein applying suction around the sleeving comprises applying a suction clamp around the sleeving, at or near the open end of the sleeving.

6. The method of claim 5 wherein moving the open end of the sleeving towards the second end of the tubing comprises moving the suction clamp towards the second end of the tubing.

7. The method of claim 1 further comprising separating the sleeving applied over the tubing from remaining sleeving.

8. The method of claim 7 wherein separating the sleeving comprises melting a portion of the sleeving with one or more heating blades.

9. The method of claim 7 further comprising displacing the tubing into a hopper, after separating the sleeving applied over the tubing from remaining sleeving.

10. An apparatus for applying flexible sleeving over tubing, the apparatus comprising
a cinch adapted to create a seal within the sleeving at a distance from the tubing and the cinch also being adapted to allow the sleeving to be moved through the cinch towards a far end of the tubing while maintaining a seal within the sleeving at a distance from the tubing;
a conduit for applying gas into the far end of the tubing;
a sleeving mover adapted to move the sleeving along the tubing.

11. The apparatus of claim 10 wherein the cinch comprises a surface and a roller, the surface and the roller being adapted to create the seal in the sleeving when the sleeving is fed between the surface and the roller.

12. The apparatus of claim 11 wherein the surface is another roller.

13. The apparatus of claim 10 wherein the seal is a hermetic seal.

14. The apparatus of claim 10 wherein the sleeving mover comprises a suction clamp adapted to fit around the sleeving at or near an open end of the sleeving after the sleeving is applied over a near end of the tubing and the suction clamp is adapted to apply suction to provide a force on a portion of the sleeving away from the tubing.

15. The apparatus of claim 14 wherein the suction clamp is mounted on a movable carriage, wherein the movable carriage is adapted to move towards the far end of the tubing.

16. The apparatus of claim 10 wherein the conduit for applying gas comprises a nozzle in communication with an air compressor, wherein the nozzle is adapted to be sealed in communication with the far end of the tubing.

17. The apparatus of claim 10 further comprising a separator adapted to separate the sleeving applied over the tubing from remaining sleeving.

18. The apparatus of claim 17 wherein the separator comprises one or more heating blades adapted to melt through the sleeving.

19. The apparatus of claim 10 further comprising a displacer adapted to displace the tubing into a hopper, after sleeving has been applied to the tubing.

20. An apparatus for applying flexible sleeving over tubing, the apparatus comprising
a cinching means adapted to create a seal within the sleeving at a distance from the tubing, and the cinching means also being adapted to allow the sleeving to be pulled through the cinching means towards a far end of the tubing while maintaining a seal within the sleeving, at a distance from the tubing;
a means for applying compressed air into the far end of the tubing; and
a moving means for moving the sleeving over the tubing.
